(19) United States
(12) Patent Application Publication
(10) Pub. No.: US 2002/0092895 A1
(43) Pub. Date: Jul. 18, 2002

(54) Formation of a solder joint having a transient liquid phase by annealing and quenching

(76) Inventors: Edmund Blackshear, Wappingers Falls, NY (US); Pedro Chalco, Yorktown, NY (US)

Correspondence Address: International Business Machines Corporation, 2070 Route 52, Hopewell Junction, NY, 12533, US

(21) Appl. No.: 09/759,113

(22) Filed: Jan. 12, 2001

(51) Int. Cl. B23K 31/02; B23K 35/24

(52) U.S. Cl. 228/226; 228/245

(57) ABSTRACT

Disclosed is a method to provide a transient liquid phase solder joint by annealing and quenching. The invention allows the attainment of a single phase solder joint at room temperature which will not reflow in subsequent thermal processing above the initial reflow temperature and thus obviates the need for a solder material hierarchy.

### BACKGROUND OF THE INVENTION

This invention relates to semiconductor processing, and more particularly to a method for creating a solder joint having a transient liquid phase by annealing and quenching.

In the semiconductor industry various components need to be joined together and a different method or process for each component may be employed. The performance of high speed computers increasingly demands higher performance packaging and interconnection methods. The surface mounting method is sometimes used to connect one semiconductor component to another. Usually, one or both of the semiconductor components are provided with conductive pads, and then using reflow solder these semiconductor components are joined together. The semiconductor components may be a chip, a plastic laminate or a substrate, such as for example, a multi layer ceramic substrate. Current practice in plastic ball grid array (PBGA) flip chip assembly requires solder reflow assembly parameters which accommodate the temperature limitations of cost effective industry standard laminate substrate materials.

In such electronic assemblies, it is desirable to have a hierarchy of solders having decreasing melting points for subsequent levels of assembly, such that a solder joint does not reflow in a later process. This is traditionally accomplished by selecting solder alloys with decreasing melting points. This is a problem as there are a limited number of alloys and compositions with appropriate melting points and physical properties

An alternative that has been recently proposed is the use of a material which undergoes a transition in composition during soldering, such that it melts at a given temperature only once, and will not melt in later processing at the same temperature. This is done by providing layered metalurgies, which upon reflow mutually dissolve, creating a mixture with a higher melting point. These are transient liquid phase solders. These layered materials have composition requirements that are difficult and expensive to produce in volume.

There are a number of methods proposed by others which use controlled solder interdiffusion to form a solder joint with an elevated melting point which will remain solid throughout subsequent thermal processing.

Merritt et al. U.S. Pat. No. 6,027,957, the disclosure of which is incorporated by reference herein, discloses a method to mount a semiconductor device to a submount by liquid interdiffusion between a first metal solder deposited on the surface of the semiconductor and a second metal solder deposited on the surface of the submount. The semiconductor surface and submount surface are placed in intimate contact and heated to a temperature greater than the melting point of the first metal solder and lower than the melting point of the second metal solder to initiate and promote liquid interdiffusion between the first and second solders.

Galasco et al. U.S. Pat. No. 5,432,998, the disclosure of which is incorporated by reference herein, discloses a method of laminating circuitized polymeric dielectric panels with pad to pad electrical connections between the panels. The pad to pad electrical connection is provided by a transient liquid phase formed bond. A gold-tin alloy on the gold rich side of the gold-tin eutectic is used as the bonding alloy. The gold-tin initially forms a eutectic melt at a low temperature. With increasing time at the higher melting temperature of the adhesive and/or the dielectric polymer used in bonding, further diffusion of gold occurs and a non-eutectic gold-tin alloy is formed having a higher melting point than any temperature attained in subsequent processing.

Davis et al. U.S. Pat. No. 5,280,414, the disclosure of which is incorporated by reference herein, discloses a method of simultaneously laminating circuitized dielectric layers using a transient liquid bonding technique where two elements are selected which will form a eutectic at one low temperature and, during exposure to the higher lamination temperature, will solidify to form an alloy which will only remelt at a temperature higher than any required by any subsequent lamination.

Notwithstanding the prior art there remains a need to solve the problems associated with the production and expense of liquid diffusion based transient liquid phase materials using conventional low cost materials and processes and solid state diffusion post joining.

Thus, a purpose of the present invention is to eliminate the need for a solder material hierarchy.

It is another purpose of the present invention to provide a transient liquid phase solder joint without providing layered materials whose composition requirements are difficult and expensive to produce in volume.

These and other purposes of the present invention will become more apparent after referring to the following description considered in conjunction with the accompanying drawings.

### BRIEF SUMMARY OF THE INVENTION

The present invention discloses a method of forming a transient liquid phase solder joint at a given temperature. Certain binary mixtures of metal have a eutectic point and significant solid solubility, greater than 1.0 wt %, of one metal in the other. Certain ternary and quaternary mixtures of metal will have similar properties. Examples of such mixtures of metal include lead/tin, tin/bismuth and silver/copper.

A solder joint is formed by depositing a eutectic mixture of metals on one side of a first article to be joined, and a non-eutectic mixture of the same metals on one side of a second article to be joined. The articles to be joined are then heated to a temperature above the melting point of the eutectic mixture to form a metallurgical bond. Subsequent to soldering, the solder joint is annealed for a period of time at an elevated temperature, but below the eutectic melting point, such that the two original materials interdiffuse completely. The assembly is then quenched by rapid cooling to produce a solder joint with the properties of a single high melt phase at a temperature where two phases would normally exist for a material mixture of the given composition.

The resulting transient liquid phase solder joint will not reflow in subsequent excursions to the initial reflow temperature. This obviates the need for a solder material hierarchy by creating a solder joint which will reflow during the initial join cycle but will not reflow in subsequent thermal processing. It also solves the problems associated with the production and expense of liquid diffusion based transient liquid phase materials by using conventional low cost materials and processes and solid state diffusion post joining.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 shows a schematic representation of a conventional tin-lead phase diagram.

FIG. 2 is a schematic view of a mixed phase solder joint in accordance with the main embodiment of the invention.

FIG. 3 shows a schematic representation of a tin-lead phase diagram with a description of the composition changes in accordance with the main embodiment of the invention.

FIG. 4 is a schematic view of a single phase solder joint in accordance with the main embodiment of the invention.

### DETAILED DESCRIPTION OF THE INVENTION

The purposes of the present invention have been achieved by providing, according to the present invention, a method for forming a solder joint having a transient liquid phase at ambient temperature.

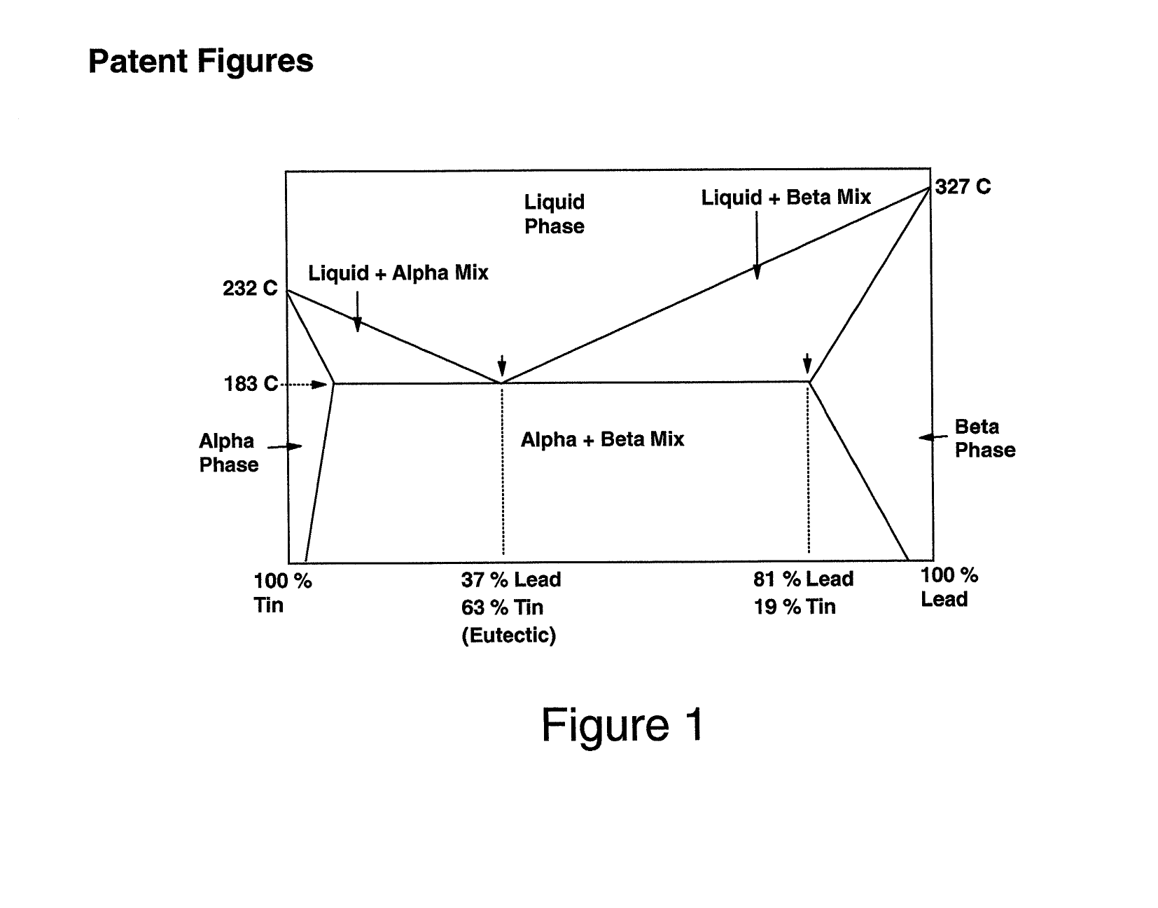

Referring to the figures in more detail, and particularly referring to FIG. 1, there is shown a tin (Sn)-lead (Pb) schematic phase diagram showing the melting temperature of the pure metals, the eutectic composition, the tin content of the eutectic composition (63 wt %) and the maximum tin solubility in lead (19 wt %). Also shown are the alloy phase regions denominated alpha, beta and liquid, and the regions where a mixture of any two phases coexist. The phase diagram describes the atomic configuration that alloys tend to assume under equilibrium conditions following the tendency of nature to reach the lowest energy in a given system. The most common binary alloy system used in electronics for solder joining is the Sn—Pb system. As shown in FIG. 1, a solder alloy with 63 wt % tin, remainder lead, has the lowest melting temperature of any possible alloy composition. This is called the eutectic composition.

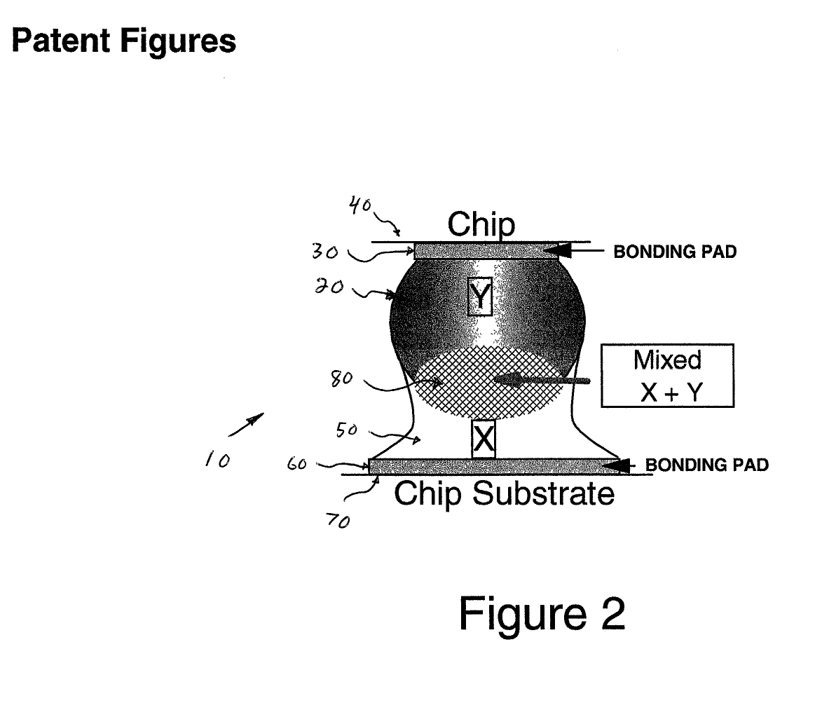

Referring now to FIG. 2, there is shown a typical “flip chip” Sn—Pb solder joint 10 which is used as the main embodiment of the invention. A flip chip solder joint 10 consists of alloy Y 20 deposited as a solder bump on chip pad 30 on a chip 40, and eutectic alloy X 50 which is deposited as a solder layer to a substrate pad 60 on a chip carrier substrate 70. Upon heating (solder reflow) eutectic alloy X 50 melts and wets both the solder bump alloy Y 20 and the substrate pad 60. A “mixed phase” region 80 containing X and Y phases forms also at the interface between eutectic alloy X 50 and alloy Y 20. In this solder joint configuration a chip 40 is attached to a chip carrier substrate 70 using a high-lead solder bump, alloy Y 20, and a eutectic solder layer, eutectic alloy X 50. Typically the tin content of the alloy Y 20 composition ranges from 3 wt % to 5 wt %. When the two solder materials are in intimate contact and exposed to a temperature above the eutectic melting temperature (183° C.) the eutectic solder layer, eutectic alloy X 50, melts thus forming the solder joint. Typically, this temperature, called the reflow temperature, ranges from 210° C. to 240° C. and the reflow time is of the order of 1 to 3 minutes. After cooling to room temperature the microstructure of the solder joint is as shown in FIG. 2. Here, except for the “mixed phase” region 80, the eutectic alloy X 50 and the solder bump alloy Y 20 remain basically unchanged in composition due to the relatively short period of time of the heating excursion used to form the solder joint 10. It must be noted that if heated again to a temperature above the eutectic melting temperature this solder joint 10 configuration will melt in all regions where the eutectic compositions, eutectic alloy X 50 and “mixed phase” region 80, exists and that there are several occasions where this melting occurs along the manufacturing operations leading to the final packaging of the chip device, and that this melting action in the solder joint 10 diminishes significantly the functional reliability of the chip device. The present invention solves the re-melting problem.

After the solder joint 10 has been formed and reaches room temperature it is heated again to a temperature below the eutectic melting temperature (183° C.) for an extended period of time that will range nominally from 1 hour to 100 hours depending on the temperature. This operation is known in the art as annealing. It is not a requirement that the solder joint 10 be cooled to room temperature prior to annealing although this would be compatible with most manufacturing processes. The solder joint 10, after the initial reflow, could be cooled directly to the annealing temperature below the eutectic melting temperature.

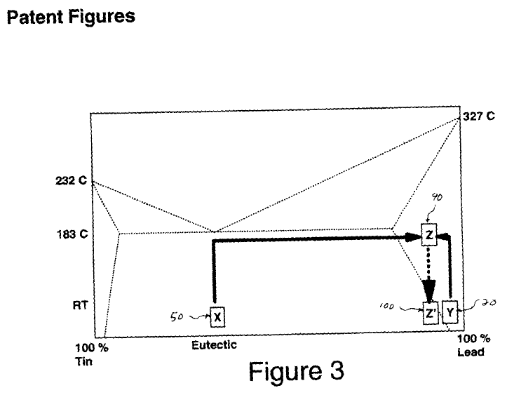

FIG. 3 shows a phase diagram which depicts the composition changes undergone during the mixing of two Sn—Pb alloys with compositions consisting of eutectic alloy X 50 and alloy Y 20. Initially (not shown) the two alloys are heated to a temperature above the eutectic point (183° C.) in order to achieve melting of eutectic alloy X 50 which is necessary to form a solder joint. Next, the solder joint 10 is either cooled to a temperature below the eutectic point or cooled to ambient and heated to a temperature below the eutectic point (<183° C.) where both eutectic alloy X 50 and alloy Y 20 stay in their solid phases (no melting) and are kept at this temperature for a period of time long enough for atomic diffusion to occur. As shown by the arrows in FIG. 3, the tin composition of eutectic alloy X 50 is diluted (moves to the right) while the tin composition of alloy Y 20 increases (moves to the left). The changes in composition occur by an atomic diffusion process that drives toward attaining a single phase (homogeneous) composition alloy Z 90. Following the attainment of the composition alloy Z 90 the solder joint 10 is rapidly cooled down to room temperature at a rate of 50 to 100 degrees C. per minute to result in composition alloy Z′ 100.

As shown in FIG. 3, annealing will produce a solder material, alloy Z 90, with a homogeneous one-phase (Beta phase) structure at the annealing temperature. The composition of solder material alloy Z 90 is less than 19 wt % Sn, although the precise amount will depend on the relative starting amounts of eutectic alloy X 50 and alloy Y 20. The solder bump, alloy Y 20, has a relatively large volume compared to the eutectic layer, eutectic alloy X 50. The ratio of alloy Y 20 to eutectic alloy X 50 is approximately 10:1 respectively. After annealing, alloy Z 90, when cooled at 50 to 100 degrees C. per minute, a normal cooling rate used in conventional belt furnaces, will not decompose into two phases and will remain a one-phase material, alloy Z′ 100, at room temperature.

Under these conditions, as shown by the phase diagram in FIG. 3, an annealed solder joint can be heated above the eutectic melting temperature without causing melting in any region of the solder joint. Furthermore, as shown in FIG. 1, depending on the composition of alloy Z 90, the temperature where the “Liquid+Beta” region is reached increases with decreasing tin content. Experience tells us that it is preferable for the composition of alloy Z 90 not to exceed the 15 wt % tin content in order to keep a safe margin for melting to be avoided.

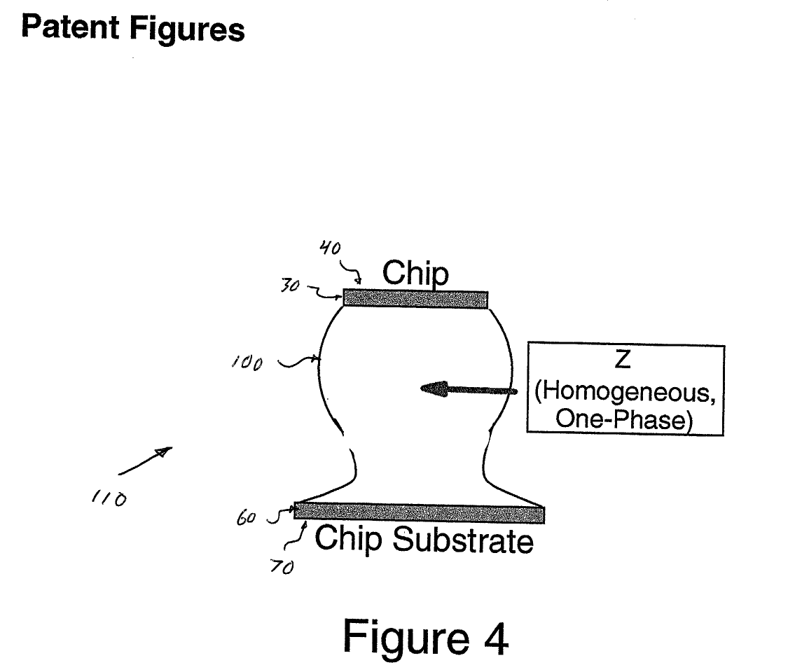

Referring now to FIG. 4, there is shown the transient liquid phase Sn—Pb solder joint 110 which is the final product of the present invention. The transient liquid phase solder joint 110 consists of alloy Z′ 100 which is a single phase composition and provides an interconnection between the chip 40 and the chip carrier substrate 70 which will not reflow during subsequent processing above the initial reflow temperature.

While the preferred embodiment of the present invention employs a binary mixture of lead and tin, it is noted that utilization of other binary mixtures are also applicable where the binary mixtures of metal have a eutectic point and significant solid solubility, greater than 1.0 wt %, of one metal in the other. Accordingly, the present invention is not limited to a binary mixture of lead and tin. Examples of other applicable binary mixture of metals include tin/bismuth and silver/copper. In addition, the present invention is not limited to binary mixtures of metal. Certain ternary mixtures of metal such as lead and tin in combination with copper, gold or bismuth, and quaternary mixtures of metal, such as lead and tin in combination with copper, gold and/or bismuth, are applicable to the present invention as well.

While the preferred embodiment of the present invention employs a eutectic alloy deposited as a solder layer to a substrate pad on a chip carrier, the present invention is not limited to a eutectic alloy. A near eutectic alloy, for example 60 wt % tin and 40 wt % lead, are applicable to the present invention as well.

It will be apparent to those skilled in the art having regard to this disclosure that other modifications of this invention beyond those embodiments specifically described here may be made without departing from the spirit of the invention. Accordingly, such modifications are considered within the scope of the invention as limited solely by the appended claims.

What is claimed is:

1. A method of forming a solder joint having a transient liquid phase, the method comprising the steps of:
depositing a first composition of metals having a eutectic point on a first article to be joined;
depositing a second composition of metals on a second article to be joined wherein the constituents of the first and second compositions of metals are the same and the second composition of metals has a higher melting range than the first composition of metals;
placing the first article to be joined in contact with the second article to be joined;
heating the articles to be joined to a temperature above the melting point of the eutectic composition of the first composition of metals for a predetermined period of time to form a mixed-phase solder joint;
holding the articles to be joined at a temperature below the melting point of the eutectic composition of the first composition of metals for a predetermined period of time, to cause the first and second compositions of metals to mix homogeneously in the solid state and form a single phase solder joint; and
cooling the articles to be joined at a predetermined rate to maintain the single phase solder joint at ambient temperature.

2. The method of claim 1 wherein the first and second compositions of metal are binary compositions.

3. The method of claim 1 wherein the first and second compositions of metal are ternary compositions.

4. The method of claim 1 wherein the first and second compositions of metal are quaternary compositions.

5. The method of claim 1 wherein the first and second compositions of metal comprise lead and tin.

6. The method of claim 1 wherein the first and second compositions of metal comprise tin and bismuth.

7. The method of claim 1 wherein the first and second compositions of metal comprise silver and copper.

8. The method of claim 1 wherein the first and second compositions of metal have a solid solubility of one in the other greater then 1.0 wt %.

9. The method of claim 1 wherein the first composition of metals have a near eutectic composition.
